(19) United States
(12) Patent Application Publication
(10) Pub. No.: US 2020/0226694 A1
(43) Pub. Date: Jul. 16, 2020

(54) REDUCING SUPPLY-DEMAND GAP

(71) Applicant: Microsoft Technology Licensing, LLC, Redmond, WA (US)

(72) Inventors: Lu Chen, Sunnyvale, CA (US); Shaunak Chatterjee, Sunnyvale, CA (US); Ankan Saha, San Francisco, CA (US)

(21) Appl. No.: 16/248,946

(22) Filed: Jan. 16, 2019

(51) Int. Cl. G06Q 50/00; G06F 16/951; H04L 12/58

(52) U.S. Cl. CPC G06Q 50/01; H04L 51/046; H04L 51/32; G06F 16/951

(57) ABSTRACT

A computer-implemented method may determine content items regarding a subject to be high demand and sufficient supply, low demand and supply constrained, high demand and supply constrained, or low demand and supply constrained. The computer-implemented method may determine the following: a supply and demand of content items regarding a subject for members, supply demand ratios for the content items regarding the subject for each of the plurality of members, a median supply demand ratio of the supply demand ratios, a total demand for the content items regarding the subject, a median total demand of total demands for the content items regarding subjects for the members, and a median of median supplies demand ratios for the content items regarding the subjects for the members. The method may perform steps to improve demand or supply of a connection network.

### TECHNICAL FIELD

The present disclosure generally relates to computer technology for reducing a supply-demand gap in connection networks. More specifically, the present disclosure relates to determining supply and demand characteristics of content items and identifying opportunities to create connections between members that would reduce supply-demand gap for content items regarding a subject.

### BACKGROUND

The rise of the Internet has given rise to the increase in the use of connection networks by members, and a corresponding rise in the number of content items that are published or posted by members of the connection network. Often, members of the connection networks are not presented with a sufficient supply of articles regarding a topic or language to meet a demand of the members to consume the articles or content items.

### DESCRIPTION OF THE DRAWINGS

Some embodiments are illustrated by way of example and not limitation in the FIG.s of the accompanying drawings, in which:

FIG. 1 illustrates a system for reducing supply demand gap, in accordance with some embodiments;

FIG. 2 illustrates a system for reducing supply-demand gap, in accordance with some embodiments;

FIG. 3 illustrates a system for reducing supply demand gap in accordance with some embodiments;

FIG. 4 illustrates a system for reducing supply demand gap in accordance with some embodiments;

FIG. 5 illustrates a system for reducing supply demand gap in accordance with some embodiments;

FIG. 6 is a block diagram of a connection network system in accordance with some embodiments;

FIG. 7 illustrates a graph of median supply demand ratio (SDR) vs. total demand in accordance with some embodiments;

FIG. 8 illustrates a computer-implemented method for reducing supply demand gap in accordance with some embodiments;

FIGS. 9 & 10 illustrate a computer-implemented method for reducing supply demand gap in accordance with some embodiments; and

FIG. 11 illustrates a diagrammatic representation of a machine in accordance with some embodiments.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

A benefit of connections networks is their ability to create a community of members that are interested in the same topic or language. Members may have a feed where a connection network determines which articles or content items to display to the members based on connections the member has with other members. Members may interact with the articles or content items displayed on their feed. For example, members may post articles regarding the topic or language, members may like an article, members may share an article, members may comment on an article, and members may publish an article.

A technical problem encountered by connection networks is that members demand for articles regarding a topic or language may not be met. In some cases, there may be sufficient articles available in the connection network for the members to interact with, but members may not be connected to members that produce the articles regarding the topic or language. Another technical problem encountered may be in determining which members have a demand for articles that is not being met. For example, some members may want to read more articles regarding a topic or language, but they may not be connected to members that are producing the articles regarding the topic or language. Additionally, another technical problem that may be encountered is determining topics or languages where there may be a supply-demand gap for articles for a topic or language. Often, connection networks perform no actions to meet the demand for articles regarding a topic or language from members that may be under supplied with articles regarding the topic or language.

In some embodiments, a technical solution is provided where the connection network may determine a supply of articles regarding a topic or language for a plurality of members. The supply of articles available to a first member may be determined based on a number of articles that are interacted with by second members that are connected to the first member. A demand of a member for articles regarding the topic or language may be determined based on a percentage of articles regarding the topic that the member views on their feed compared with all articles the member views on their feed. This measure of demand may provide a reliable indicator of a member's demand for articles regarding the topic or language.

in some embodiments, the connection network may determine an aggregate supply demand ratio for the articles regarding a topic or language for members of the connection network by dividing the supply of articles regarding the topic or language by the demand for articles regarding the topic or language. The connection network may determine that the aggregate supply demand ratio is lower by a threshold value than a median supply demand ratio for articles regarding a plurality of topics or languages available on the connection network. The connection network may determine to improve connections between members that produce articles regarding this topic or language with members that have a demand for the articles regarding the topic or language.

The connection network may take actions to try to improve the aggregate demand supply ratio for articles regarding the topic or language. For example, the connection network may cause to be displayed on a screen of a first member an article regarding the topic or language from a second member that has a higher production of articles regarding the topic or language than a median production of articles. The connection network may offer the first member the opportunity to form a connection with the second member, e.g., to connect with or follow. Additionally, the connection network may identify members with a higher production of articles regarding the topic or language than a median production of articles regarding the topic or language. The connection network may provide incentives for members to produce more articles regarding the topic or language.

The connection network may have tens of millions of members. The connection network may improve the connections of the network by increasing connections between members that have a higher than a median production of articles regarding a topic or language and members that have a demand for the articles. The improved connections may provide the technical advantage of improving the connections of the connection network so that articles in the system are presented to more members that would like to read the articles.

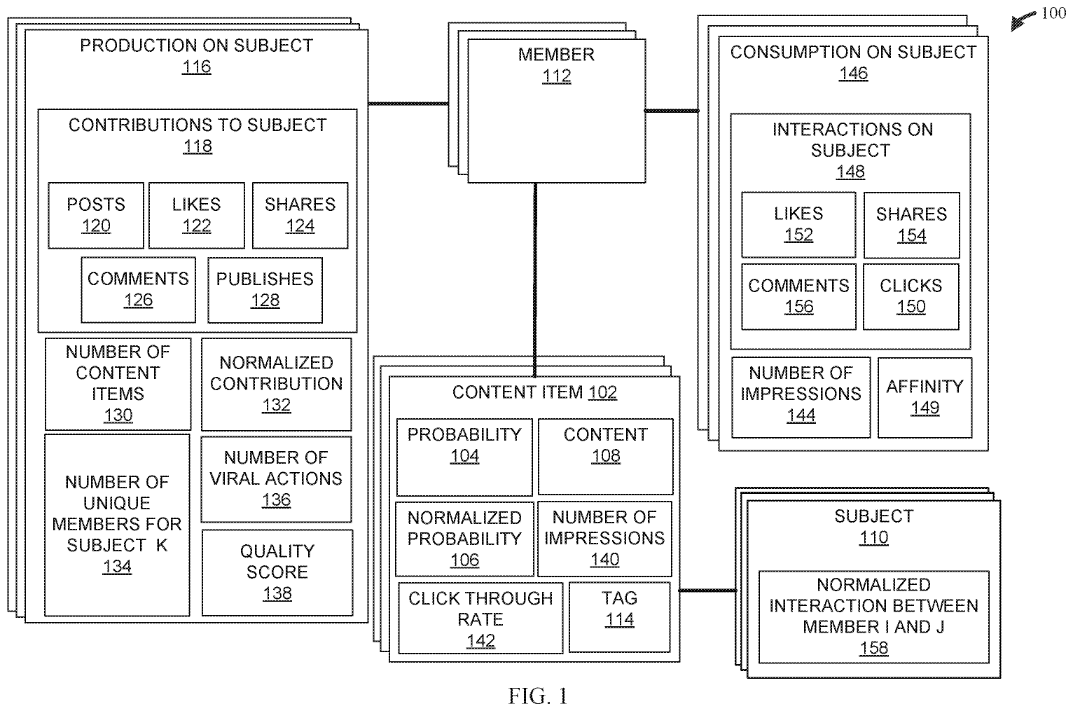

FIG. 1 illustrates a system 100 for reducing supply demand gap, in accordance with some embodiments. Illustrated in FIG. 1 is production on subject 116, member 112, consumption on subject 146, content items 102, and subject 110. Content items 102 may be articles that are produced by members 112. Content items 102 may include probability 104, normalized probability 106, number of impressions 140, content 108, and click through rate 142. In some embodiments, content items 102 are produced by outside sources, e.g., news services. In some embodiments, content items 102 are produced by outside sources and shared by a member 112. In some embodiments, content items 102 are one or more of a short post, an audio, an article, or a video.

In accordance with some embodiments, subject 110 is a topic of the content items 102, e.g., Management, Careers, Human Resources, Personal Development, Business, Culture, Management Consulting, Motivation, Innovation, Executives and Management, Working at Home, Public Speaking, Behavioral Economics, Layoffs and Job Reductions, Feminism, Email, Social Psychology, Working Hours, Lean Startups, and Wages and Salaries. In accordance with some embodiments, subject 110 is a language (written or spoken) of the content items 102, e.g., English, French, Spanish, Dutch, Portuguese, German, Italian, Swedish, Danish, Turkish, Traditional Chinese, Simplified Chinese, Japanese, German, Arabic, Hungarian, Indonesian, Hebrew, Russian, and Norwegian.

Content items 102 may be tagged (e.g., tag 114) with one or more subjects by a member 112 to indicate that the content 108 regards the tagged one or more subjects 110. In some embodiments, an article analyser (not illustrated) may analyse a content items 102 to determine one or more subjects 110 of the content 108 of the content items 102. The article analyser may determine a probability 104 that content items 102 regards subject 110. The probability 104 that content item 102 regards subject 110 may be determined in other ways, e.g., article analyser may determine that different members 112 have tagged 114 the content items 102 with different subjects 110 and the article analyser may determine a probability 104 based on the different subjects 110. The probability 104 may be represented by mⱼₖ, where j represents a jth content item of content items 102 and k represents the kth subject 110. The normalized probability 106 may be represented by mⱼₖ^{norm} (e.g., in linear form mⱼₖ^{norm}) and determined as disclosed in Equation (1) where the content items 102 are articles.

$$\begin{matrix}{m}_{jk}^{norm} = \frac{{m}_{jk}}{{\sum }_{{t}_{{k}^{′}} ∈ T ( {a}_{j} )} {m}_{jk}} , & Equation ( 1 ) \\ ( e . g . , in linear form \text{:} & \\ {m\_jk}^{⋀} norm = m\_jk / ( Σ\_ ( t\_ ( {k}^{′} ) ∈ T ( a\_j ) ) m\_jk ) ) & \end{matrix}$$

where aⱼ is article j of a group or set of articles (A); tₖ is topic or language k of a set or group of topics or languages T(aⱼ); mⱼₖ is the probability of article aⱼ belonging to topic tₖ; T(aⱼ) denotes the set of subjects 110 that article aⱼ has been tagged with (e.g., tag 114 or article analyser); and mⱼₖ^{norm} is the normalized score of article aⱼ of topic or language tₖ. Both tₖ and T(aⱼ) may be used to denote both topics and languages of subject 110.

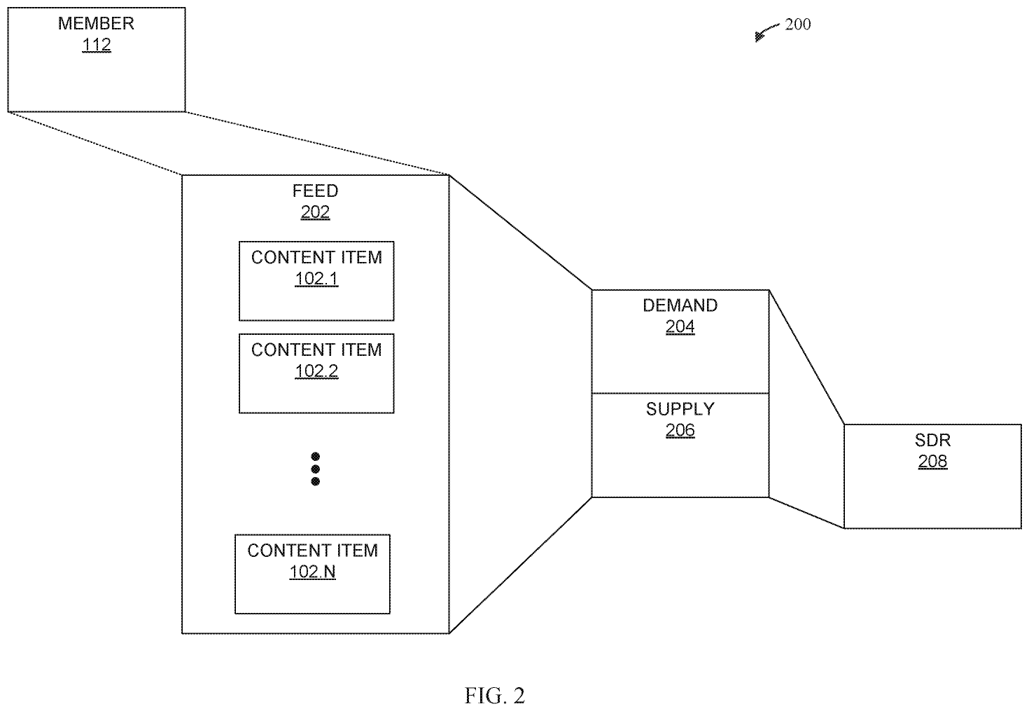

The content items 102 may have a click through rate 142, which indicates a number of times that a member 112 has clicked on the content items 102 divided by the number of impressions 142 of the content items 102, which may be the number of times the content items 102 has been presented to a member 112 (e.g., an impression of the content items 102 in the feed 202 of FIG. 2). The number of impressions 140 and click through rate 142 may be for a content items 102 for a plurality of members 112 or may be for a single member 112.

Member 112 may be a member of an online system, e.g., connection network 400. Member 112 may tag 114 a content items 102 with a subject 110. The tag 114 may include an indication of the content item 102, subject 110, and member 112.

Production on subject 116 may include contributions to subject 118, number of content items 130, normalized contribution 132, number of unique members for subject K 134, number of viral actions 136, and quality score 138. A member's 112 production on subject 116 (e.g., subject 110) may be measured by a number of contributions to subject 118, which may include posts 120, likes 122, shares 124, comments 126, and publishes 128. A post 120 may be a post of a content items 102 authored by the member 112. The like 122 may be a like (e.g., selection of a like button) of a content item 102. The share 124 may be a share of a content item 102 with other members 112 that are connected with the member 112. The comment 126 may be a comment on a content items 102 (e.g., a post 120 or publish 128 from another member 112). Publishes 128 may be similar or the same as post 120 for a content items 102 with the content items 102 being longer (at least a couple of paragraphs) or with more options for sharing the content items 102 with more members 112 that are connected with the member 112. The number of content items 130 may be a number of articles that a member 112 has contributed (e.g., contributions to subject 118) for a subject 110. Normalized contribution 132 may be a normalized contribution (e.g., number of content items 130 normalized for probability 104 that a content items 102 regards subject 110) for a member 112.

Member 112 may be termed a producer for subject 110, which may be measured based on production on subject 116. The number of content items 130 may be the number of content items 130 that the ith member 112 (vᵢ) has contributions to subject 118 (e.g., posts 120, likes 122, shares 124, comments 126, publishes 128 to content items 102 regarding tₖ, i.e., the kth subject 110). Production of the ith member 112 (v₁) for the kth subject 110 may be represented by pᵢₖ and may be equal to or based on the number of content items 130.

Normalized production of the ith member 112 (vᵢ) for the kth subject 110 may be represented by pᵢₖ^{norm} and may be equal to or based on the normalized contributions 132. The normalized contribution 132 of the ith member 112 (vᵢ) on subject (tₖ) 110 may be represented by pᵢₖ^{norm}, which is calculated by Equation (2): pᵢₖ^{norm}=Σₐ_{ⱼ}_{∈A}_{^{contr}}₍ᵥ_{ᵢ}₎mⱼₖ^{norm} (e.g., in linear form: p_ik\hat{ }norm=Σ_(a_j ∈\hat{ }contr (v_i))m_jk\hat{ }norm) where A^{contr} (vᵢ) is the set of articles (number of content items 130) that member 112 (vᵢ) has contributed to (e.g., contributions to subject 118) and mⱼₖ^{norm} is determined based on Equation (1).

Number of unique members for subject K 134 (uᵢₖ, i.e., for member i and topic k) may be the number of members 112 who have at least a threshold (e.g., 1, 5, 10, 20, 100, etc.) of impressions (e.g., number of impressions 140) of any content items 102 that regards the subject 110 K. In some embodiments, number of unique members for subject K 134 may only include members 112 that have at least a first threshold (e.g., 1, 5, 10, 20, 100, etc.) of contributions to subject 118 K and/or a second threshold (e.g., 1, 5, 10, 20, 100, etc.) of a number of impressions 140 of subject 110 K.

The number of viral actions 136 that the ith member 112 (vᵢ) has received on the kth topic 110 (tₖ) may be represented by fᵢₖ. A viral action 136 may be a share to another connection network, an email of the content items 102 or link, etc. The quality score 138 of the articles (e.g., number of articles) that the ith member 112 (vᵢ) has contributed to the kth topic (tₖ) may be represented by qᵢₖ which may be determined or calculated by a click through rate 142 of other members 112 on the content items 102 of the number of content items 130.

Consumption on subject 146 may include interactions on subject 148, number of impressions 144, and affinity 149. The number of impressions 144 of the ith member 112 (vᵢ) for the kth subject 110 (tₖ) may be represented by cᵢₖ, where cᵢₖ may indicate the number of impressions of the kth subject 110 (tₖ) (e.g., content items 102 related to topic or language k) that the ith member 112 (vᵢ) has been presented.

The normalized value of cᵢₖ may be represented by cᵢₖ^{norm}, which may be calculated by Equation (3): cᵢₖ^{norm}=Σₐ_{ⱼ}_{∈A}_{^{imp}}₍ᵥ_{ᵢ}₎mⱼₖ^{norm} (e.g., in linear form: c_ik\hat{ }norm=Σ_(a_j ∈A\hat{ }imp (v_i))m_jk\hat{ }norm), where A^{imp}(vᵢ) is the set of content items 102 (e.g., articles) that the ith member 112 (vᵢ) has impression on (e.g., content items 102 that were included in number of impressions 144) and mⱼₖ^{norm} may be determined using Equation (1).

The interactions on subject 148 may be represented by eᵢₖ, which may indicate the interactions (including clicks 150, likes 152, comments 156, and shares 154) of the ith member 112 (vᵢ) on the kth subject 110 (tₖ).

The normalized eᵢₖ may be represented by eᵢₖ^{norm} and determined by Equation (4): eᵢₖ^{norm}=Σₐ_{ⱼ}_{∈A}_{^{int}}₍ᵥ_{ᵢ}₎mⱼₖ^{norm} (e.g., in linear form: e_ik\hat{ }norm=Σ_(a_j ∈A\hat{ }int (v_i))m_jk\hat{ }norm), where A^{int} (vᵢ) is the set of content items 102 (e.g., articles) that the ith member 112 (vᵢ) has interacted with and mⱼₖ^{norm} may be determined using Equation (1). Affinity 149 of the ith member 112 with the kth topic 110 may be represented by aᵢₖ, which may be determined by the click through rate (eᵢₖ^{norm}/cᵢₖ^{norm}) of the ith member 112 on the kth topic 110.

Subject 110 may include normalized interaction between member i and j 158, which may be determined by reduce supply demand gap 302 for a subject 110 (e.g., tₖ) as a |V|×|V|matrix represented by G^{(k)}, where Gᵢⱼ^{(k)} is the normalized interactions on subject 110 (tₖ) between the ith member 112 (vᵢ) and the jth member 110 (vⱼ), and where |V| represents all the members 112. In some embodiments, reduce supply demand gap 326 may determine Gᵢⱼ^{(k)} and G^{(k)} based on content from the data layer 406, e.g., member activity and behaviour data 320.

FIG. 2 illustrates a system 200 for reducing supply-demand gap, in accordance with some embodiments. Illustrated in FIG. 2 is member 112, feed 202, supply 204, demand 206, and supply demand ratio (SDR) 208.

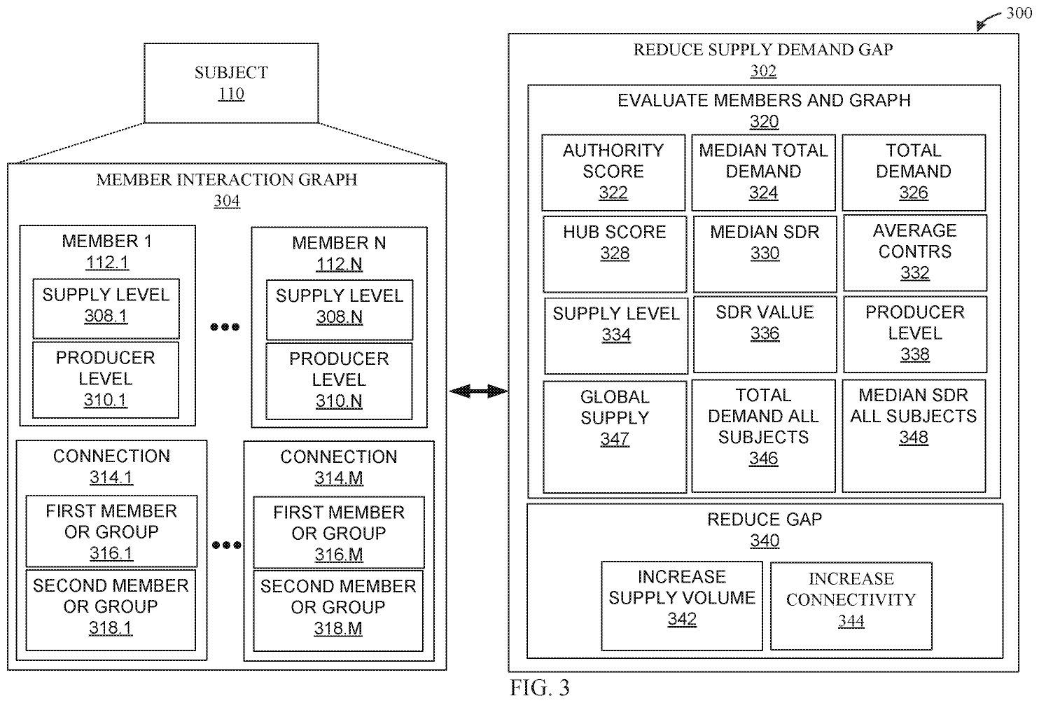

The feed 202 may be a feed of member 112. The feed 202 may be a place where content items (e.g., content items 102) may be displayed to the member 112, e.g., a screen of a laptop, smart phone, tablet, or other device. The feed 202 may display content item 102.1, 102.2, through 102.N. The content items 102 may be published (e.g., publishes 128) by other members 112. The content items that are displayed on the feed 202 may be dependent on connections (e.g., 314 of FIG. 3) the member 112 has with other members 112.

In some embodiments, the demand 204 may be represented by dᵢₖ for demand of the ith member 112 (vᵢ) on the kth subject 110 (tₖ). The demand 204 for the ith member 112 for the kth topic 110 may be determined according to Equation (5):

$${d}_{ik} = {c}_{i} * \frac{{a}_{i k}}{{\sum }_{{k}^{′} = 1}^{\vert T \vert} {a}_{{ik}^{′}}}$$

(e.g., in linear form: d_ik=c_i*a_ik/(Σ_(k′=1)\hat{ }|T|a_ik))), where cᵢ=Σₖ₌₁^{|V|}cᵢₖ^{norm} (e.g., in linear form: c_i=Σ_(k′=1)\hat{ }(|T|)c_(ik′)\hat{ }norm)) the total normalized impressions that the ith member 112 (v₁) has in feed 202, |T| is the number of subjects 110, and aᵢₖ is the number of content items 102 on topic 110 k that have had impressions for the ith member 112. An impression may be a display of a content items 102 to the member 112 on the feed 202. The ith member 112 will have higher demand dᵢₖ on the subjects 110 that they have shown more interest in.

The supply 206 for the ith member 112 for the kth topic 110 may be represented by Equation (6): sᵢₖ=Σᵥ_{ᵢ}_{∈N(v}_{ᵢ}₎pᵢₖ^{norm} (e.g., in linear form: s_ik=Σ_(v_(i′)∈N(v_i)) p_(i′k)\hat{ }norm), where N (vᵢ) denotes the set of members 112 that the ith member (vᵢ) connects with or follows, e.g., those members 112 that can or have had a content items 102 displayed on the feed 202 of the ith member 112 for subject 110 k.

A feed mechanism to the feed 202 (e.g., an application server module 210) may determine which content items 102 are displayed to the ith member 112 (v₁). The feed mechanism to the feed 202 may display for the ith member 112 (vᵢ) content items 102 that his or her connections (e.g., as represented in social graph data 218 or connections 314) has contributed to, e.g., contributions to subjects 118, which may include posts 120, likes 122, comments 126, shares 124, and publishes 128.

Supply to demand ratio (SDR) 208 of the ith member 112 (vᵢ) of the kth topic or language (tₖ) may be determined by Equation (7): rᵢₖ=sᵢₖ/dᵢₖ, where sᵢₖ is the supply 206 for the ith member 112 (vᵢ) of the kth topic 110, which may be determined by Equation (6), and dᵢₖ is the demand 204 for the ith member 112 (vᵢ) of the kth topic 110, which may be determined by Equation (5). Reduce supply demand gap 302 may be configured to determine SDR 208.

FIG. 3 illustrates a system 300 for reducing supply demand gap in accordance with some embodiments. Illustrated in FIG. 3 is subject 110, member interaction graph 304, and reduce supply demand gap 302. The subject 110 may be the same or similar as subject 110 of FIG. 1. Reduce supply demand gap 302 may include evaluate members and graph 320 and reduce gap 340.

Evaluate members and graph 320 may determine the member interaction graph 304 based on the subject 110. The members 112 may be the same or similar as member 112. Member 1 112.1 through member N 112.N may be members (e.g., 112) that either have some production on subject 110 or have some consumption on subject 146. The members 112 may be the same or similar as number of unique members for subject K 134. In some embodiments, the members 112 considered may be limited to some minimum production on subject 116 and/or consumption on subject 146. For example, to be included in the member interaction graph 304 a member 112 may have to have at least h number of impressions 140 or g contributions to subject 118. Other criteria may be used for a member 112 to be included in the member interaction graph 304.

Members 112 may include a supply level 308 and producer level 310 that may be determined by evaluate members and graphs 320. For example, supply level 308 may be determined by supply level 334 using Equation (6). Producer level 310 may be deter mined by producer level 338 using Equation (2). The connections 314.1 through connection 314.M may be connections between the members 112 or a group (not illustrated). For example, a connection 314 may indicate that member 1 112.1 and member 2 112.2 are connected (e.g., first member or group 316.1 being member 1 112.1 and second member or group 316.1 being member 2 112.2.). The connection 314 may be due to member 1 112.1 and member 2 112.2 being part of each other's friends or network. A connection 314 may mean that the first member or group 316.1 may have content items 102 from the second member or group 316.2 placed in the feed 202 (FIG. 2) of the first member or group 316.1 (and vis-a-versa). Connections 314 may be formed on the basis of consumption on subject 146. For example, member 1 112.1 may like 152 a content item of content items 102 that member 2 112.1 publishes 128. Connections 314 between members 112 may be formed based on other actions of the members 112. A connection 314 between two members 112 may mean that if one of the member 112 interacts with a content items 102 (e.g., interactions on subject 148) then the other member 112 would be able to see the content items 102 in their feed 202 (FIG. 2).

Evaluate members and graph 320 may include authority score 322, median total demand 324, total demand 326, hub score 328, median SDR 330, average contributions 332, supply level 334, SDR value 336, producer level 338, global supply 347, total demand all subjects 346, and median SDR all topic or languages 348. The authority score 322 may indicate the value of content (e.g., content items 102) a member 112 created (e.g., contributions to subject 118.) The authority score 322 may be the same or similar to quality score 138. The authority score 322 may be increased when other members 112 interact with the content items 102 published by the member 112, e.g., the other member 112 may perform one of the actions in interactions on subject 148. The authority score 322 may be increased more based on a higher hub score 328 of a member 112 that interacts (e.g., interactions on subject 148) with the content (e.g., content items 102) created (e.g., publishes 128) by the member 112.

The hub score 328 of a member 112 indicates the value of interactions with other members 112. A hub score 328 of a member 112 may be increased when the member 112 interacts (e.g., interactions on topic or language) with content (e.g., content items 102) that was published (e.g., publishes) by authorities (e.g., members 112 that have been identified as authorities on subject 110).

The total demand 326 may be determined based on Equation (5). The median total demand 324 may be determined based on determining the demand for each of the members 112. The SDR value 336 may be determined based on Equation (7). The median SDR 330 may be determined based on determining the SDR value 336 for each of the members 112. The average contributions 332 may be determined based on determining the contributions (e.g., contributions to subjects 118) from each member 112.

The supply level 334 for subject 110 and member 112 may be determined by Equation (6) as disclosed above. Producer level 310 for subject 110 and member 112 may be determined by Equation (2) as disclosed above. The global supply 347 may be determined based on Equation (6) by adding the value for each of the members 112 of member count for the topic 110 (e.g., computer chips). The total demand all subjects 346 may be determined by determining the demand for each topic or language, e.g., using Equation (5). The total demand all subjects 346 may be used to compare total demand 326 (which is for the subject 110) with total demand all subjects 346. Median SDR all topics or languages 348 may be determined by determining the median SDR 330 (which is for the subject 110) for all topics or languages.

Reduce gap 340 may include increase supply volume 342 and increase connectivity 344. Reduce gap 340 may determine if member interaction graph 304 has a low SDR for subject 110, which may indicate that the overall production is low (e.g., global supply 347) or the members 112 who are interested in the subject 110 are not connected (e.g., connections 314) with the member 112 who have a high producer level 338. Reduce gap 340 may determine the member interaction graph 304 has a low SDR for subject 110 (e.g., low median SDR) by comparing the median SDR 330 to median SDR all topics or languages 348, e.g., a low value for the median SDR 330 may be that the median SDR 330 is below the median SDR all topics or languages 348 (or below the median SDR all topics or languages 348 by a threshold value).

Reduce gap 340 may include increase supply volume 342 and increase connectivity 344. Increase supply volume 341 may identify members 112 who can help increase the supply volume (e.g., global supply 347) and relieve the low median SDR 330 of the subject 110. Increase connectivity 344 may identify members 112 with an under supply (e.g., SDR value 336 being low) and attempt to connect (e.g., connection 314) the members 112 with members 112 that would improve their supply (e.g., member 112 with a high producer level 338).

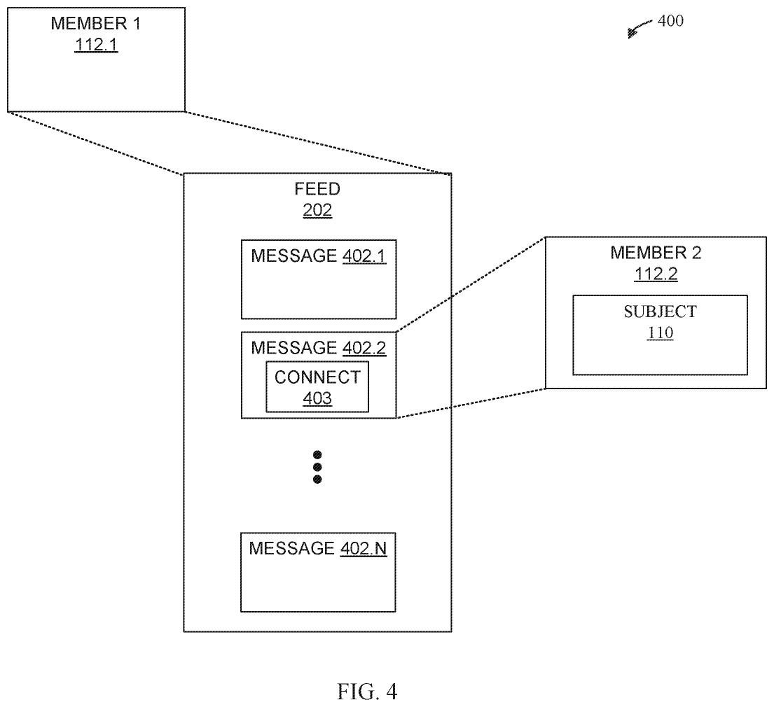

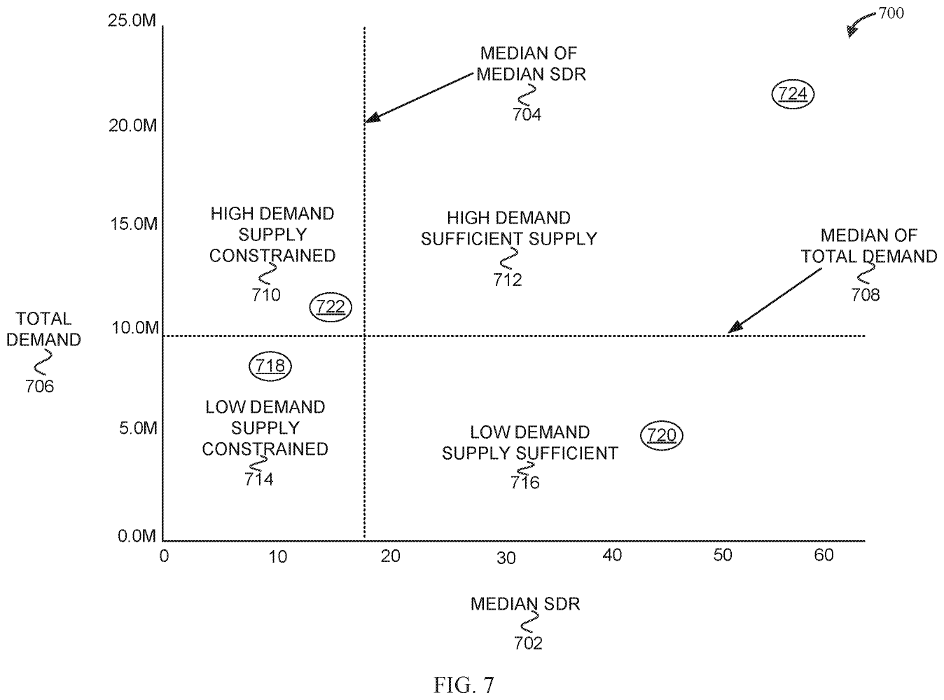

FIG. 4 illustrates a system 400 for reducing supply demand gap in accordance with some embodiments. Illustrated in FIG. 4 is member 1 112.1, feed 202, and member 2 112.2. Member 1 112.1 and member 2 112.2 may be the same or similar as member 112 of FIG. 1. Messages 402 may be content items 102, invitations, content items, etc. Reduce gap 340 may determine that member 1 1121 is an under-supplied member for subject 110. For example, member 112.1 may have a supply level 308 (FIG. 3) that is lower by a threshold (e.g., 1, 5, 10, 20, 100, etc.) than a median supply level for members 112 that are part of the member interaction graph 304, e.g., a supply level 308 that is lower than median of median SRD 704 of FIG. 7. Reduce gap 1040 may cause message 402.2 to be presented in the feed 202 of member 1 112.1. Message 402.2 may include connect 403, which may be an invitation to connect with member 2 406.2 and may include an indication that member 2 406.2 is knowledgeable regarding subject 110.

The message 402.2 may include content items 102 published by member 112.2 along with a button to connect with member 2 112.2. Reduce gap 340 may select member 2 112.2 based on member 2 112.2 having a higher producer level 310.N than a threshold and/or median producer level for the members 112 that are included in member interaction graph 304 for subject 110. The goal of reduce gap 340 may be to increase the supply to member 1 112.1, which may be accomplished be creating new connections (e.g., connection 314) between member 1 112.1 and members 112 (e.g., member 2 112.2) that have a higher producer level 310 for the subject 110 than a threshold (e.g., 1, 2, 5, 10, 100, etc.) plus a median producer level 310 for the members 112 included in the member interaction graph 304 for subject 110.

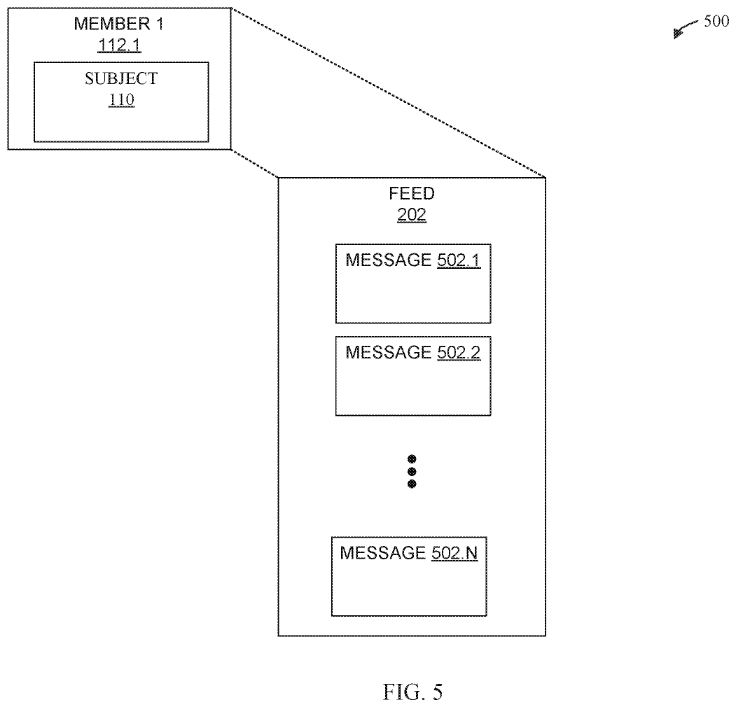

FIG. 5 illustrates a system 500 for reducing supply demand gap in accordance with some embodiments. Illustrated in FIG. 5 is member 1 112.1 and feed 202. Reduce gap 340 may determine that member 1 112.1 is a member that has a high producer level 310 (e.g., a threshold plus a media producer level 310) and that the subject 110 has a lower median SDR 330 than the median SDR all topics or languages 348, e.g., lower than median of median SDR 704. Reduce gap 1040 may cause a message 502.2 to be displayed on the feed 202 of member 1 112.1. The message 502 may be an incentive for member 1 112.1 to produce more content for subject 110, e.g., contributions to subject 118. The message 502.2 may be a notification that is displayed on menu bar. The message 502.2 may indicate that there is a low supply for subject 110. The message 502 may include invitations to connect with other members 112 that have a supply level 308 of subject 110 that is lower than member 112.1, e.g., lower than median of median SDR 704. Reduce gap 340 may select members 112 that have a high demand (e.g., as determined by Equation (5)) and lower supply (e.g., as determined by Equation (6)). Reduce gap 340 may select members 112 with a SDR (e.g., as determined by Equation (7)) that is lower by a threshold than median SDR 330. Reduce gap 340 may select member 112.1 based on a high authority score 322, e.g., an authority score 322 that is higher by a threshold than a median authority score. Reduce gap 340 may select member 112.1 based on a high hub score 328, e.g., a hub score 328 that is higher by a threshold than a median hub score 328.

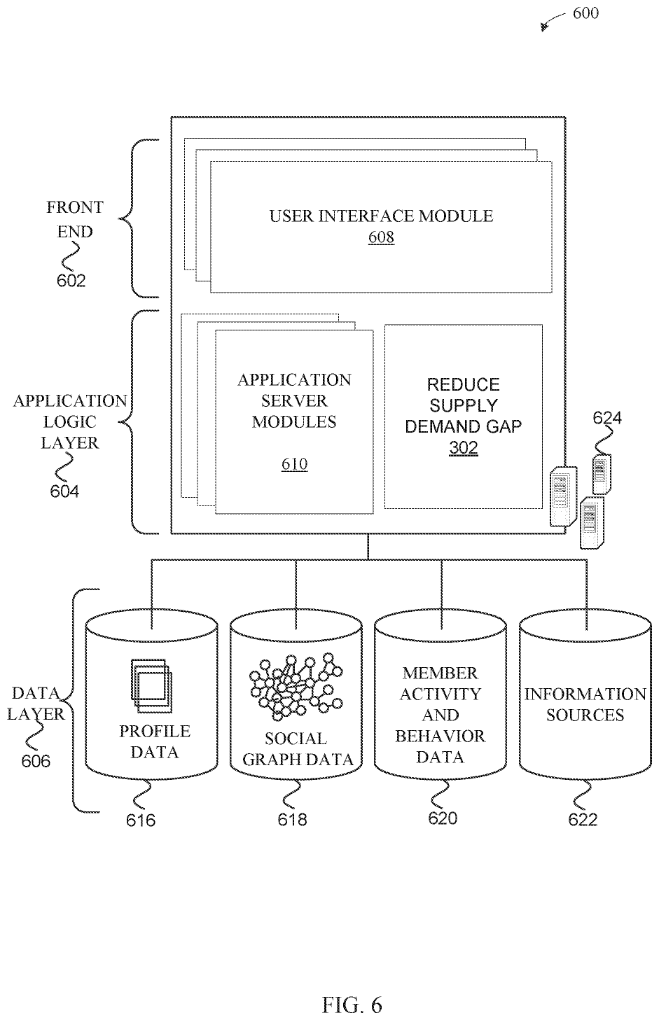

FIG. 6 is a block diagram of a connection network system 600, in accordance with some embodiments. The connection network system 600 may be based on a three-tiered architecture, comprising a front-end layer 602, application logic layer 604, and data layer 606. Some embodiments implement the connection network system 600 using different architectures. The connection network system 600 may be implemented on one or more computers 624. The computers 624 may be servers, personal computers, laptops, portable devices, etc. The computers 624 may be distributed across a network. The connection network system 600 may be implemented in a combination of software, hardware, and firmware.

As shown in FIG. 6, the front end 602 includes user interface modules 608. The user interface modules 608 may be one or more web services. The user interface modules receive requests from various client-computing devices and communicate appropriate responses to the requesting client devices. For example, the user interface modules 608 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems. The feed 202 may be implemented with a user interface module 608 in accordance with some embodiments.

As shown in FIG. 6, the data layer 606 includes profile data 616, social graph data 618, member activity and behaviour data 620, and information sources 622. Profile data 616, social graph data 618, and member activity and behaviour data 620, and/or information sources 622 may be databases. One or more of the data layer 606 may store data relating to various entities represented in a social graph. In some embodiments, these entities include members, companies, and/or educational institutions, among possible others. Consistent with some embodiments, when a person initially registers to become a member of the connection network system 600, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in profile data 616. Profile data may include preferences for subjects 110.

With some embodiments, a member's profile data will include not only the explicitly provided data, but also any number of derived or computed member profile attributes and/or characteristic, which may become part of one of more of profile data 616, social graph data 618, member activity and behaviour data 620, and/or information sources 622. For example, the activity may include production on subject 116 and/or consumption on subject 146.

Once registered, a member may invite other members, or be invited by other members, to connect (e.g., connection 314) via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. For example, if member 112.1 follows member 112.2 then content items 102 that are published (e.g., publishes 128) by member 112.2 may be displayed on the feed 202 of member 112.1. In addition to following another member, a user may elect to follow a company, a topic, a conversation, or some other entity. In general, the associations and relationships that a member has with other members and other entities (e.g., companies, schools, etc.) become part of the social graph data 618. With some embodiments the social graph data 618 may be implemented with a graph database, which is a particular type of database that uses graph structures with nodes, edges, and properties to represent and store data. In this case, the social graph data 618 reflects the various entities that are part of the social graph, as well as how those entities are related with one another.

With various alternative embodiments, any number of other entities might be included in the social graph data 618, and as such, various other databases may be used to store data corresponding with other entities. For example, although not shown in FIG. 6, consistent with some embodiments, the system may include additional databases for storing information relating to a wide variety of entities, such as information concerning various online or offline people, job announcements, companies, groups, posts, slide shares, articles, and so forth.

With some embodiments, the application server modules 610 may include one or more activity and/or event tracking modules, which generally detect various user-related activities and/or events, and then store information relating to those activities/events in, for example, member activity and behaviour data 620. For example, tracking modules may identify when a user (e.g., member 112) performs an action in contributions to subject 118 or interactions on subject 148 and may store the action in member activity and behaviour data 620. Additionally, a tracking module may detect the interactions that a member has with different types of content.

Information sources 622 may be one or more additional information sources. For example, information sources 622 may outside sources of content items 102. The application server modules 610, which, in conjunction with the user interface module 608, generate various user interfaces (e.g., web pages) with data retrieved from the data layer 606. In some embodiments, individual application server modules 610 are used to implement the functionality associated with various applications, services and features of the social network service. For instance, a messaging application, such as an email application, an instant messaging application, or some hybrid or variation of the two, may be implemented with one or more application server modules 610. Of course, other applications or services may be separately embodied in their own application server modules 610. In some embodiments applications may be implemented with a combination of application service modules 610 and user interface modules 608. For example, reduce supply demand gap 302 may be implemented with a combination of back-end modules, front-end modules, and modules that reside on a user's computer (not illustrated). Reduce supply demand gap 302 may be the same or similar as reduce supply demand gap 302 as disclosed in conjunction with FIG. 3. For example, the connection network system 600 may download a module to a web browser running on a user's computer (not illustrated), which may communicate with an application server module 610 running on a server 624 which may communicate with a module running on a back-end database server (not illustrated).

The connection network system 600 may provide a broad range of applications and services that allow members the opportunity to share and receive information, often customized to the interests of the member. For example, with some embodiments, the connection network system 600 may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in social graph data 618. When a member joins a group, his or her membership in the group may be reflected in the social graph data 618. In some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data 618.

As is understood by skilled artisans in the relevant computer and Internet-related arts, each module or engine shown in FIG. 6 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 6. However, a skilled artisan will readily recognize that various additional functional modules and engines may be used with a social network system, such as that illustrated in FIG. 6, to facilitate additional functionality that is not specifically described herein. Furthei more, the various functional modules and engines depicted in FIG. 6 may reside on a single server computer or may be distributed across several server computers in various arrangements. Moreover, although depicted in FIG. 6 as a three-tiered architecture, the disclosed embodiments are by no means limited to such architecture.

FIG. 7 illustrates a graph 700 of median supply demand ratio (SDR) 702 vs. total demand 706 in accordance with some embodiments. Illustrated in FIG. 7 is median SDR 702, median of median SDR (T2) 704, total demand 706, median of total demand (T1) 708, high demand supply constrained 710, high demand sufficient supply 712, low demand supply constrained 714, and low demand supply sufficient 716.

A consumer of a subject 110 may be determined to be a member 112 who has at least h impressions (e.g., number of impressions 140) or g actions (e.g., contributions to subjects 118). The median SDR 702 may be determined for the kth subject 110 for all i members 112 using Equation (8): median_{c}_{ᵢₖ}_{>=10 or e}_{ᵢₖ}_{>=3} SDR(rₖ)=median of Equation (7) for all i members (vᵢ). In some embodiments, the ith member 112 for the kth subject 110 is only included if aᵢₖ of Equation (5) is greater than 10 (another number be used including 0) or the eᵢₖ for the ith member 112 of the kth subject 110 is greater than 3 (another number be used including 0). Equation (8) may be written as{median}_{c_{ik}>=10\ or \e_{ik}>=3}{\SDR(r}_k).

The total demand 706 may be determined using Equation (5) where the ith member 112 for the kth subject 110 is only included if aᵢₖ of Equation (5) is greater than 10 (another number be used including 0) or the eᵢₖ for the ith member 112 of the kth subject 110 (or language 108) is greater than 3 (another number may be used including 0).

Median of median SDR. 704 may be the median of median SDRs 702. The median of total demand 708 may be the median of total demand 706. The graph 700 may be for subsets of subjects 110, e.g., one graph 700 may be for topics (or a subset of topics) and another graph may be for languages (or a subset of languages).

High demand sufficient supply 712 may be where a total demand 706 of a kth subject 110 is greater than the median of total of total demand 708 and a median SDR 702 is greater than a median of median SDR 704. For example, Careers 724 as disclosed below. High demand supply constrained 710 may be where a total demand 706 of a kth subject 110 is greater than the median of total of total demand 708 and a median SDR 702 is less than a median of median SDR 704. For example, Product Management 722 as disclosed below. Low demand supply constrained 714 may be where a total demand 706 of a kth subject 110 is less than the median of total of total demand 708 and a median SDR 702 is less than a median of median SDR 704. For example, Computer Chips 718 as disclosed below. Low demand supply sufficient 716 may be where a total demand 706 of a kth subject 110 is less than the median of total of total demand. 708 and a median SDR 702 is greater than a median of median SDR 704. For example, Public Speaking 720 as disclosed below. In some embodiments, less than and/or greater than may include equal to.

In some embodiments, the gap between supply and demand on the languages (e.g., subjects 110) with a large supply-demand gap and with a high total demand 1204 may be reduced by increasing the supply of a language or improving connectivity between members 112 that produce articles in the language and members 112 that are consumers of and have a high-demand for the language 108.

Table 1 illustrates topic, member count, total demand, global supply, and median SDR. The topic includes Computer Chips 718, Public Speaking 720, Product Management 722, and Careers 724. The member count is the number of members 112 that are either part of the total demand or the global supply. The total demand may be determined based on Equation (5) by summing the demand for each of the members 112 of member count. The global supply may be determined based on Equation (6) by summing the supply for each of the members 112 of member count for the subject 110 (e.g., computer chips). The median SDR may be the median of all the SDRs SDR 208) determined for each of the members 112 of the member count. In some embodiments, some members 112 may be excluded from the calculations based on low interactivity with the subject 110. Table 1 is for illustrative purposes and actual numbers may be different.

TABLE 1
Demand, supply and median supply-demand ratio of a few topics

| | MEMBER | TOTAL | GLOBAL | MEDIAN |
|---|---|---|---|---|
| TOPIC | COUNT | DEMAND | SUPPLY | SDR |
| Computer | 319,073 | 8,000,000 | 6139.73 | 9 |
| Chips (718) | | | | |
| Public | 1,693,749 | 5,000,000 | 235466.15 | 45 |
| Speaking (720) | | | | |
| Product | 4,619,338 | 11,000,000 | 91676.77 | 15 |
| Management | | | | |
| (722) | | | | |
| Careers (724) | 23,452,513 | 22,000,000 | 481192.37 | 58 |

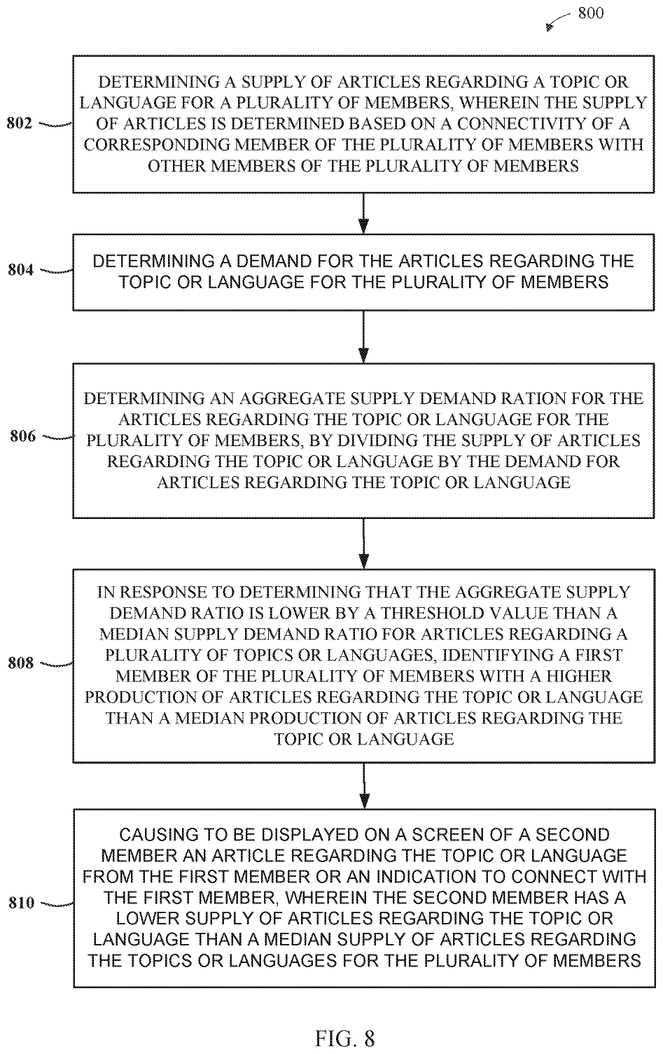

FIG. 8 illustrates a computer-implemented method 800 for reducing supply demand gap in accordance with some embodiments. The method 800 may begin at operation 802 with determining a supply of articles regarding a topic or language for a plurality of members, wherein the supply of articles is determined based on a connectivity of a corresponding member of the plurality of members with other members of the plurality of members. For example, reduce supply demand gap 302 or evaluate members and graph 320 may be configured to determine the supply as disclosed herein. For example, reduce supply demand gap 302 or evaluate members and graph 320 may determine the supply based on Equation (6).

The method 800 may continue at operation 804 with determining a demand for the articles regarding the topic or language for the plurality of members. For example, reduce supply demand gap 302 or evaluate members and graph 320 may be configured to determine demand as disclosed herein. For example, reduce supply demand gap 302 or evaluate members and graph 320 may determine demand based on Equation (5).

The method 800 may continue at operation 806 with determining an aggregate supply demand ratio for the articles regarding the topic or language for the plurality of members, by dividing the supply of articles regarding the topic or language by the demand for articles regarding the topic or language. For example, reduce supply demand gap 302 or evaluate members and graph 320 may be configured to determine aggregate supply demand ratio as disclosed herein. For example, reduce supply demand gap 302 or evaluate members and graph 320 may determine aggregate supply demand ratio based on Equation (7).

The method 800 may continue at operation 808 with in response to determining that the aggregate SDR is lower by a threshold value than a median SDR for articles regarding a plurality of topics or languages, identifying a first member of the plurality of members with a higher production of articles regarding the topic or language than a median production of articles regarding the topic or language. For example, reduce supply demand gap 302 or evaluate members and graph 320 may be configured to determine the aggregate SDR is lower by a threshold value (e.g., 1, 2, 3, 4, . . . , 1000) than a median SDR for articles regarding a plurality of topics or languages as disclosed herein. For example, reduce supply demand gap 302 or evaluate members and graph 320 may be configured to determine that a subject such as product management 722 (Table 1) has an aggregate SDR that is lower by a threshold value (e.g., 3) than a median SDR (704).

For example, reduce supply demand gap 302 or evaluate members and graph 320 may be configured to identify a first member of the plurality of members with a higher production of articles regarding the topic or language than a median production of articles regarding the topic or language as disclosed herein. As another example, reduce supply demand gap 302 or evaluate members and graph 320 may be configured to identify a first member of the plurality of members with a higher production of articles regarding the topic or language than a median production of articles regarding the topic or language based on Equation (2).

If a determination is that the aggregate SDR is lower by a threshold value than a median SDR for articles regarding a plurality of topics or languages, then the method 800 may continue at operation 810 with causing to be displayed on a screen of a second member an article regarding the topic or language from the first member or an indication to connect with the first member, wherein the second member has a lower supply of articles regarding the topic or language than a median supply of articles regarding the topics or languages for the plurality of members. For example, reduce supply demand gap 302, evaluate members and graph 320, and/or a user interface module 608 may be configured to cause to be displayed on a screen of a second member an article regarding the topic or language from the first member or an indication to connect with the first member as disclosed herein. For example, message 402.2 may be displayed on the feed 202 of member 1 112.1 (second member), which may include an indication to connect with the first member (e.g., connect 403 to connect with member 2 112.2). In some embodiments, reduce supply demand gap 302 or evaluate members and graph 320 may be configured to identify a second member that has a lower supply of articles regarding the topic or language than a median supply of articles regarding the topics or languages for the plurality of members as disclosed herein. For example, reduce supply demand gap 302 or evaluate members and graph 320 may use Equation (6) to identify a second member that has a lower supply of articles regarding the topic or language than a median supply of articles regarding the topics or languages for the plurality of members.

The method 800 may be performed by the machine 1400. One or more of the operations of method 800 may be optional. Additionally, one or more of the operations of method 800 may be performed in a different order. Moreover, method 800 may include one or more additional operations.

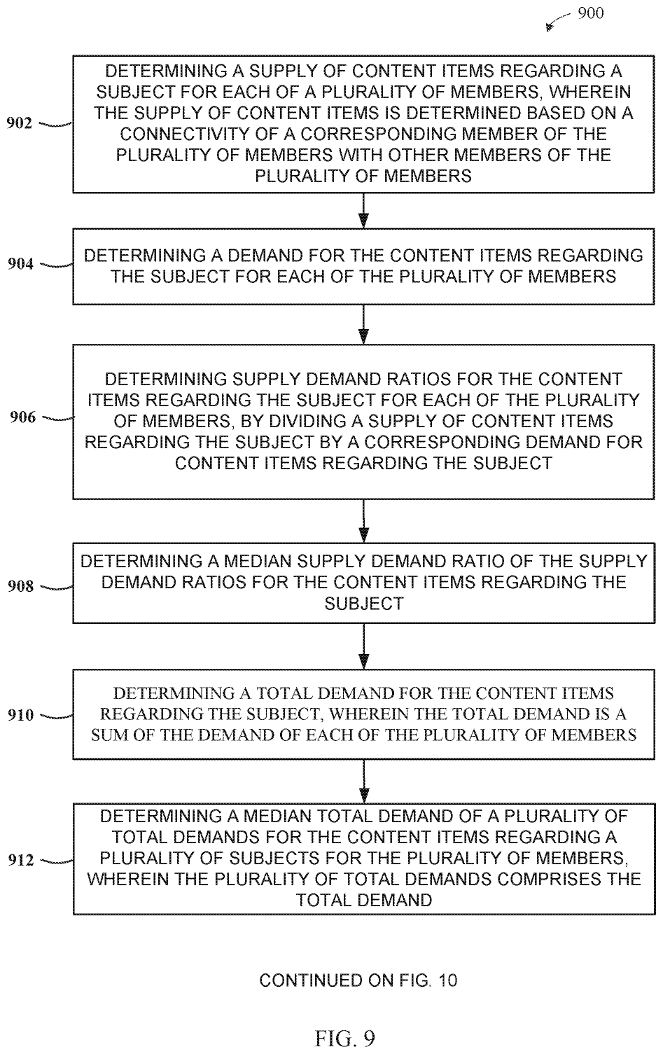

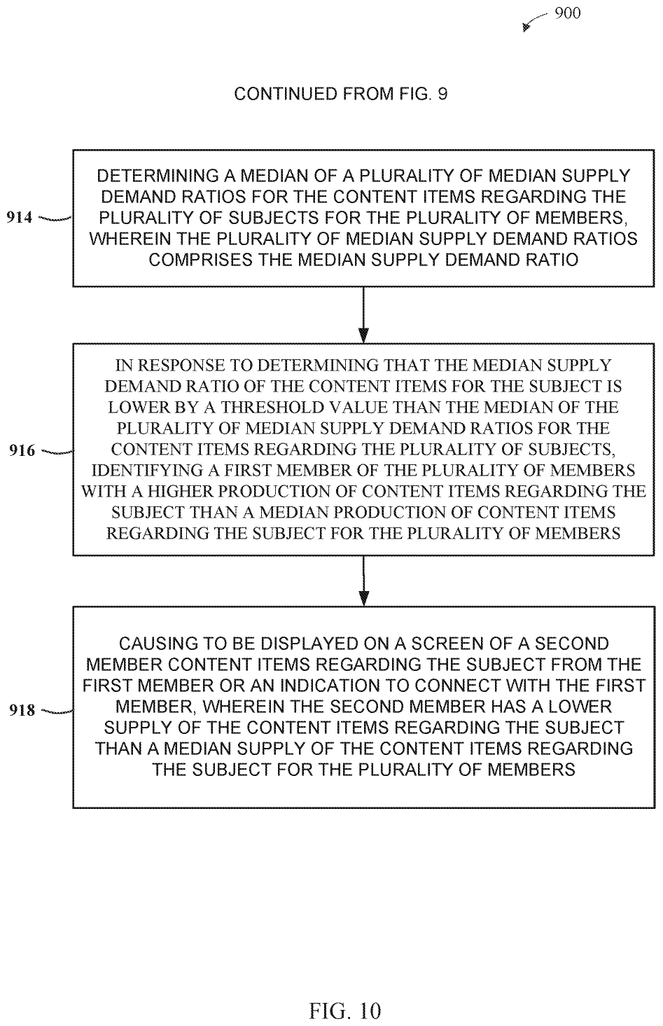

FIGS. 9 & 10 illustrate a computer-implemented method 900 for reducing supply demand gap in accordance with some embodiments. The method may begin at operation 902 with determining a supply of content items regarding a subject for each of a plurality of members, where the supply of content items is determined based on a connectivity of a corresponding member of the plurality of members with other members of the plurality of members. For example, reduce supply demand gap 302 or evaluate members and graph 320 may be configured to determine the supply as disclosed herein. For example, reduce supply demand gap 302 or evaluate members and graph 320 may determine the supply based on Equation (6).

The method 900 may continue at operation 904 with determining a demand for the content items regarding the subject for each of the plurality of members. For example, reduce supply demand gap 302 or evaluate members and graph 320 may be configured to determine demand as disclosed herein. For example, reduce supply demand gap 302 or evaluate members and graph 320 may determine demand based on Equation (5).

The method 900 may continue at operation 906 with determining supply demand ratios for the content items regarding the subject for each of the plurality of members, by dividing a corresponding supply of content items regarding the subject by a corresponding demand for content items regarding the subject. For example, reduce supply demand gap 302 or evaluate members and graph 320 may be configured to determine aggregate supply demand ratio as disclosed herein. For example, reduce supply demand gap 302 or evaluate members and graph 320 may determine aggregate supply demand ratio based on Equation (7).

The method 900 may continue at operation 908 with determining a median supply demand ratio of the supply demand ratios for the content items regarding the subject. For example, the median SDR 702 may be determined for the kth subject 110 for all i members 112 using Equation (8): median_{c}_{ᵢₖ}_{>=10 or e}_{ᵢₖ}_{>=3} SDR(rₖ)=median of Equation (7) for all i members (vᵢ).

The method 900 may continue at operation 910 with determining a total demand for the content items regarding the subject, where the total demand is a sum of the demand of each of the plurality of members. For example, the total demand 326 may be determined based on Equation (5).

The method 900 may continue at operation 912 with determining a median total demand of a plurality of total demands for the content items regarding a plurality of subjects for the plurality of members, where the plurality of total demands comprises the total demand. For example, median of total demand 708 may be the median of total demand 708.

The method 900 may continue at operation 914 with determining a median of a plurality of median supply demand ratios for the content items regarding the plurality of subjects for the plurality of members, where the plurality of median supply demand ratios comprises the median supply demand ratio. For example, median of median SDR 704 may be the median of median SDRs 702 as disclosed in conjunction with FIG. 7.

The method 900 may continue at operation 916 in response to determining that the median supply demand ratio of the content items for the subject is lower by a threshold value than the median of the plurality of median supply demand ratios for the content items regarding the plurality of subjects, identifying a first member of the plurality of members with a higher production of content items regarding the subject than a median production of content items regarding the subject for the plurality of members. For example, reduce supply demand gap 302 or evaluate members and graph 320 may be configured to determine the aggregate SDR is lower by a threshold value (e.g., 1, 2, 3, 4, . . . , 1000) than a median SDR for content regarding a plurality of subjects as disclosed herein. For example, reduce supply demand gap 302 or evaluate members and graph 320 may be configured to determine that a subject such as product management 722 (FIG. 7) has an aggregate SDR that is lower by a threshold value (e.g., 3) than a median SDR (704). For example, reduce supply demand gap 302 or evaluate members and graph 320 may be configured to identify a first member of the plurality of members with a higher production of articles regarding the topic or language than a median production of articles regarding the topic or language as disclosed herein. As another example, reduce supply demand gap 302 or evaluate members and graph 320 may be configured to identify a first member of the plurality of members with a higher production of articles regarding the topic or language than a median production of articles regarding the topic or language based on Equation (2).

If a determination is that the aggregate SDR is lower by a threshold value than a median SDR for content regarding a plurality of subjects, then the method 900 may continue at operation 918 with causing to be displayed on a screen of a second member content items regarding the subject from the first member or an indication to connect with the first member, where the second member has a lower supply of the content items regarding the subject than a median supply of the content items regarding the subject for the plurality of members.

For example, reduce supply demand gap 302, evaluate members and graph 320, a user interface module 608 may be configured to cause to be displayed on a screen of a second member an article regarding the topic or language from the first member or an indication to connect with the first member as disclosed herein. For example, message 402.2 may be displayed on the feed 202 of member 1 112.1 (second member), which may include an indication to connect with the first member (e.g., connect 403 to connect with member 2 112.2). In some embodiments, reduce supply demand gap 302 or evaluate members and graph 320 may be configured to identify a second member that has a lower supply of articles regarding the topic or language than a median supply of articles regarding the topics or languages for the plurality of members as disclosed herein. For example, reduce supply demand gap 302 or evaluate members and graph 320 may use Equation (6) to identify a second member that has a lower supply of articles regarding the topic or language than a median supply of articles regarding the topics or languages for the plurality of members.

The method 900 may be performed by the machine 1100. One or more of the operations of method 900 may be optional. Additionally, one or more of the operations of method 900 may be performed in a different order. Moreover, method 900 may include one or more additional operations.

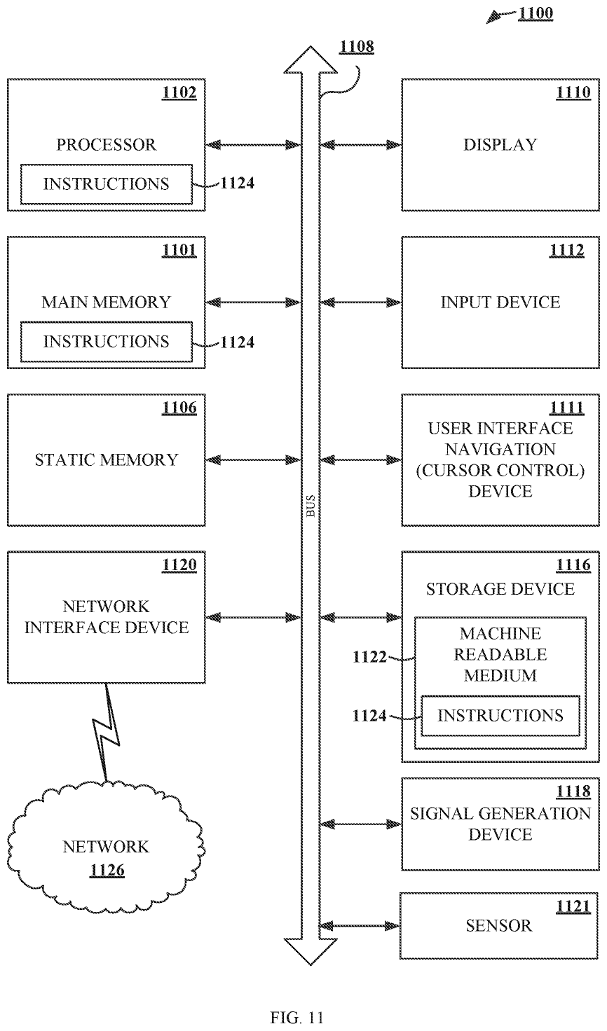

FIG. 11 illustrates a diagrammatic representation of a machine 1100 in accordance with some embodiments. The machine 1100 may be in the example forms of a computer system and within which instructions 1124 (e.g., software) cause the machine 1100 to perform any one or more of the methodologies discussed herein may be executed. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perfortn any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light emitting diode (LED) display, a liquid crystal display (LCD), a projector, or a cathode ray tube (CRT)). The machine 1100 may also include an input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), a sensor 1121 (e.g., microphone, camera, etc.), and a network interface device 1120.

The storage unit 1116 includes a machine-readable medium 1122 on which is stored the instructions 1124 (e.g., software) embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 via the network interface device 1120. The instructions 1124 may configure the machine 1100 to perform one or more of the methods disclosed in conjunction with FIGS. 1-10.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The teen “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented nodule” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method, the method comprising:
determining a supply of content items regarding a subject for each of a plurality of members, wherein the supply of content items is determined based on a connectivity of a member of the plurality of members with other members of the plurality of members;
determining a demand for the content items regarding the subject for each of the plurality of members;
determining supply demand ratios for the content items regarding the subject for each of the plurality of members, wherein the supply demand ratios are determined by dividing the supply of content items regarding the subject by a corresponding demand for content items regarding the subject;
determining a median supply demand ratio of the supply demand ratios for the content items regarding the subject;
determining a total demand for the content items regarding the subject, wherein the total demand is a sum of the demand of each of the plurality of members;
determining a median total demand of a plurality of total demands for the content items regarding a plurality of subjects for the plurality of members;
determining a median of a plurality of median supply demand ratios for the content items regarding the plurality of subjects for the plurality of members;
in response to determining that the median supply demand ratio of the content items for the subject is lower by a threshold value than the median of the plurality of median supply demand ratios for the content items regarding the plurality of subjects, identifying a first member of the plurality of members with a higher production of content items regarding the subject than a median production of content items regarding the subject for the plurality of members; and
causing to be displayed on a screen of a second member content items regarding the subject from the first member or an indication to connect with the first member, wherein the second member has a lower supply of the content items regarding the subject than a median supply of the content items regarding the subject for the plurality of members.

2. The computer-implemented method of claim 1, further comprising:
determining the content items regarding the subject is high demand and sufficient supply if the total demand is greater by a second threshold than the median total demand and the median supply demand ratio is greater by a third threshold than the median of the plurality of median supply demand ratios;
determining the content items regarding the subject is high demand and supply constrained if the total demand is greater by a fourth threshold than the median total demand and the median supply demand ratio is less by a fifth threshold than the median of the plurality of median supply demand ratios;
determining the content items regarding the subject is low demand and supply constrained if the total demand is less by a sixth threshold than the median total demand and the median supply demand ratio is less by a seventh threshold than the median of the plurality of median supply demand ratios; and
determining the content items regarding the subject is low demand and supply constrained if the total demand is less by a eighth threshold than the median total demand and the median supply demand ratio is greater by a ninth threshold than the median of the plurality of median supply demand ratios.

3. The computer-implemented method of claim 1, wherein determining a demand for the content items regarding the subject for each of the plurality of members further comprises:
determining the demand for the content items regarding the subject for a corresponding member of the plurality of members based on a number of impressions on a screen of the corresponding member of the content items regarding the subject compared with a total number of impressions of the content items regarding the plurality of subjects on the screen of the corresponding member regarding the content items for the plurality of subjects.

4. The computer-implemented method of claim 1, wherein determining a demand for the content items regarding the subject for each of the plurality of members further comprises:
determining the demand for the content items regarding the subject for a corresponding member of the plurality of members based on a number of impressions on a screen of the corresponding member of the content items regarding the subject and a number of actions of the corresponding member with the impressions of the number of impressions compared with a total number of impressions of the content items regarding the plurality of subjects on the screen of the corresponding member regarding the content items for the plurality of subjects and a total number of actions of the corresponding member with impressions of the total number of impressions.

5. The computer-implemented method of claim 4, wherein the an action of the number of actions is one from the following group: like the content items regarding the subject, comment on the content items regarding the subject, share the content items regarding the subject, and post the content items regarding the subject.

6. The computer-implemented method of claim 1, wherein the plurality of members publish the content items regarding the plurality of subjects.

7. The computer-implemented method of claim 1, wherein a feed of an online network is displayed on the screen of the second member, and wherein the plurality of members are members of the online network.

8. The computer-implemented method of claim 1, wherein determining the supply of content items regarding the subject further comprises:
determining the supply of content items regarding the subject for each of the plurality of members based on adding together a number of the content items regarding the subject contributed to by each member of the plurality of members that are connected with a corresponding member of the plurality of members.

9. The computer-implemented method of claim 8, wherein contributed to comprises one or more of the following: liked, commented on, shared with members of the plurality of members, and published.

10. The computer-implemented method of claim 8, wherein the number of the content items regarding the subject is normalized based on a first probability that an item of the content items regards a kth subject divided by a sum of probabilities that the item of the content items belongs to each subject of the plurality of subjects.

11. The computer-implemented method of claim 1, wherein a member of the plurality of members is excluded from the steps of determining the supply and determining the demand if the member has not interacted with the content items regarding the subject above a threshold number of times.

12. The computer-implemented method of claim 1, wherein identifying the first member of the plurality of members with a higher production of content items regarding the subject than a median production of content items regarding the subject for the plurality of members further comprises:
identifying the first member of the plurality of members with the high production of content items regarding the subject, wherein a production of content items regarding the subject is determined based on a number of posts of content items regarding the subject, a number of likes of content items regarding the subject, a number shares of content items of the subject, a number of comments on content items regarding the subject, and a number of publishes of content items regarding the subject.

13. The computer-implemented method of claim 1, wherein the content items are one or more of: a short post, an audio, an article, or a video, and the subject is a language or a topic.

14. The computer-implemented method of claim 1, further comprising:
in response to determining that the median supply demand ratio of the content items for the subject is lower by a second threshold value than the median of the plurality of median supply demand ratios for the content items regarding the plurality of subjects, causing to be displayed on a screen of the first member an incentive to post or publish the content items regarding the subject.

15. A machine-readable medium storing computer-executable instructions stored thereon that, when executed by at least one hardware processor, cause the at least one hardware processor to perform a plurality of operations, the operations comprising:
determining a supply of content items regarding a subject for each of a plurality of members, wherein the supply of content items is determined based on a connectivity of a corresponding member of the plurality of members with other members of the plurality of members;
determining a demand for the content items regarding the subject for each of the plurality of members;
determining supply demand ratios for the content items regarding the subject for each of the plurality of members, by dividing a corresponding supply of content items regarding the subject by a corresponding demand for content items regarding the subject;
determining a median supply demand ratio of the supply demand ratios for the content items regarding the subject;
determining a total demand for the content items regarding the subject, wherein the total demand is a sum of the demand of each of the plurality of members;
determining a median total demand of a plurality of total demands for the content items regarding a plurality of subjects for the plurality of members, wherein the plurality of total demands comprises the total demand;
determining a median of a plurality of median supply demand ratios for the content items regarding the plurality of subjects for the plurality of members, wherein the plurality of median supply demand ratios comprises the median supply demand ratio;
in response to determining that the median supply demand ratio of the content items for the subject is lower by a threshold value than the median of the plurality of median supply demand ratios for the content items regarding the plurality of subjects, identifying a first member of the plurality of members with a higher production of content items regarding the subject than a median production of content items regarding the subject for the plurality of members, and causing to be displayed on a screen of a second member content items regarding the subject from the first member or an indication to connect with the first member, wherein the second member has a lower supply of the content items regarding the subject than a median supply of the content items regarding the subject for the plurality of members.

16. The machine-readable medium of claim 15, wherein determining the demand for the articles regarding the topic or language further comprises:
determining the content items regarding the subject is high demand and sufficient supply if the total demand is greater by a second threshold than the median total demand and the median supply demand ratio is greater by a third threshold than the median of the plurality of median supply demand ratios;
determining the content items regarding the subject is high demand and supply constrained if the total demand is greater by a fourth threshold than the median total demand and the median supply demand ratio is less by a fifth threshold than the median of the plurality of median supply demand ratios;
determining the content items regarding the subject is low demand and supply constrained if the total demand is less by a sixth threshold than the median total demand and the median supply demand ratio is less by a seventh threshold than the median of the plurality of median supply demand ratios; and
determining the content items regarding the subject is low demand and supply constrained if the total demand is less by a eighth threshold than the median total demand and the median supply demand ratio is greater by a ninth threshold than the median of the plurality of median supply demand ratios.

17. The machine-readable medium of claim 15, wherein detei mining the de and for the articles regarding the topic or language further comprises:
determining the demand for the content items regarding the subject for a corresponding member of the plurality of members based on a number of impressions on a screen of the corresponding member of the content items regarding the subject compared with a total number of impressions of the content items regarding the plurality of subjects on the screen of the corresponding member regarding the content items for the plurality of subjects.

18. The machine-readable medium of claim 15, wherein determining the demand for the articles regarding the topic or language further comprises:
determining the demand for the content items regarding the subject for a corresponding member of the plurality of members based on a number of impressions on a screen of the corresponding member of the content items regarding the subject and a number of actions of the corresponding member with the impressions of the number of impressions compared with a total number of impressions of the content items regarding the plurality of subjects on the screen of the corresponding member regarding the content items for the plurality of subjects and a total number of actions of the corresponding member with impressions of the total number of impressions.

19. A computer-implemented method, the method comprising:
determining a supply of articles regarding a topic or language for a plurality of members, wherein the supply of articles is determined based on a connectivity of a corresponding member of the plurality of members with other members of the plurality of members;
determining a demand for the articles regarding the topic or language for the plurality of members;
determining an aggregate supply demand ratio for the articles regarding the topic or language for the plurality of members, by dividing the supply of articles regarding the topic or language by the demand for articles regarding the topic or language; and
in response to determining that the aggregate supply demand ratio is lower by a threshold value than a median supply demand ratio for articles regarding a plurality of topics or languages, identifying a first member of the plurality of members with a high production of articles regarding the topic or language, and causing to be displayed on a screen of a second member an article regarding the topic or language from the first member or an indication to connect with the first member, wherein the second member has a lower supply of articles regarding the topic or language than a median supply of articles regarding the topics or languages for the plurality of members.

20. The computer-implemented method of claim 19, wherein the method further comprises:
determining the demand for the articles for a corresponding member of the plurality of members based on a number of impressions on a screen of the corresponding member of the articles regarding the topic or language compared with a total number of impressions of articles on the screen of the corresponding member regarding all topics or languages.
